(19) United States
(12) Patent Application Publication
(10) Pub. No.: US 2006/0126013 A1
(43) Pub. Date: Jun. 15, 2006

(54) Sports binocular assembly

(76) Inventor: Tristram Himmele, Palm Beach, FL (US)

Correspondence Address: Clifford Kraft, 320 Robin Hill Dr., Naperville, IL, 60540, US

(21) Appl. No.: 11/351,014

(22) Filed: Feb. 9, 2006

Related U.S. Application Data
(63) Continuation-in-part of application No. 10/968,206, filed on Oct. 19, 2004.
Application No. 10/968,206 is a continuation-in-part of application No. 10/868,686, filed on Jun. 15, 2004, now Pat. No. 7,031,068.
Application No. 10/868,686 is a continuation-in-part of application No. 10/633,936, filed on Aug. 4, 2003, now abandoned.
Application No. 10/633,936 is a continuation-in-part of application No. 10/117,989, filed on Apr. 6, 2002, now Pat. No. 6,614,603.
Application No. 10/117,989 is a continuation-in-part of application No. 09/523,213, filed on Mar. 10, 2000, now Pat. No. 6,369,958.

(51) Int. Cl. G02C 1/00

(52) U.S. Cl. 351/158

(57) ABSTRACT

A helmet or headgear assembly that includes a fixed or removable display that can display any message desired by the user so that others can see it and a fixed or removable optical element such as a binocular viewer in front of the user's eyes that can be supported without using the hands. The invention can include fixed or removable accessories such as a radio, camera, earmuff, microphone and earphone. The earphone can optionally be of the noise-canceling type. All of the elements of the invention can be fixed or can be removed from the helmet or headgear and used in any combination.

This application is a continuation in part of co-pending application Ser. No. 10/968,206 filed Oct. 19, 2004 which was a continuation in part of application Ser. No. 10/868,686 filed Jun. 15, 2004 which was a continuation in part of co-pending application Ser. No. 10/633,936 filed Aug. 4, 2003 which was a continuation in part of application Ser. No. 10/117,989 filed Apr. 6, 2002, now U.S. Pat. No. 6,614,603 which was a continuation in part of application Ser. No. 09/523,213 filed Mar. 10, 2000, now U.S. Pat. No. 6,369,958. Application Ser. Nos. 10/968,206, 10/868,686, 10,633,936, 10/117,989 and 09/523,213 are hereby incorporated by reference.

### BACKGROUND

1. Field of the Invention

The present invention relates to sporting event viewing accessories, and more particularly to a sports viewing assembly, that can include display mounted on a helmet or other piece of head gear, a fixed or removable radio, fixed or removable earmuffs and a fixed or removable camera.

2. Description of the Prior Art

It is often desirable to use binoculars for better viewing the action while attending sporting events and the like. Although binoculars provide a useful mechanism for enhancing viewing of the event, they are often bothersome because the user must continuously dedicate at least one hand to supporting the binoculars. It would be advantageous to have a binocular assembly that included a hands free support mechanism for supporting the binoculars in front of the user's eyes without using any of the user's hands. In addition, it is many times desirable to be able to display a message for others to see. At a sporting event, it would be very desirable to have a piece of headgear that could contain a display where the user could display a team name, advertisement or other message.

### SUMMARY OF THE INVENTION

The present invention relates to a work or sports accessory that includes a headgear unit worn on a user's head with a fixed or removable display attached to an outside surface of the headgear unit with the display displaying an image that is visible to another person and a hands-free optical system attached to the headgear unit where the user can view distant objects. The invention can be used at sporting or other events and can be used on various jobs such as construction work.

The device can be equipped with fixed or removable accessories such as camera, radio and earmuffs where the user can pick and choose between various accessories based on the type of event or use, the weather and the user's personal preferences. The device can also provide digital music, a scanner, a microphone, a cellular telephone and any other useful accessory that can be attached to a headgear such as a hat or helmet. It is also possible to include an ice-pack in the headgear for very hot days.

In using the present invention, a user generally takes the helmet or other headgear or head support system and decides whether or not to add accessories. For example, the user can decide to add, or not to add, removable earphones, radio, earmuffs, camera, ice pack and display board. The system of the present invention is completely usable no matter what combination of accessories are added.

### BRIEF DESCRIPTION OF THE DRAWINGS

The following illustrations show aspects and embodiments of the present invention.

FIG. 1A shows a perspective view of an embodiment of the present invention with a helmet and a display.

FIG. 1B shows a side view of the embodiment of FIG. 1A.

FIG. 2A shows a perspective view of the embodiment of FIG. 1A with a removable camera added.

FIG. 2B shows a side view of the embodiment of FIG. 2A.

FIG. 3A shows the a perspective view of the embodiment of FIG. 1A with a removable radio added.

FIG. 3B shows a side view of the embodiment of FIG. 3A.

FIG. 4A shows a perspective view of the embodiment of FIG. 1A with removable earmuffs added.

FIG. 4B shows a side view of the embodiment of FIG. 4A.

FIG. 5A shows a perspective view of the embodiment of FIG. 1A with a removable optical element added.

FIG. 5B shows a side view of the embodiment of FIG. 5A.

FIG. 6A shows a perspective view of the embodiment of FIG. 5A with a removable camera added.

FIG. 6B is a side view of the embodiment of FIG. 6A.

FIG. 7A is a perspective view of the embodiment of FIG. 5A with a removable radio added.

FIG. 7B is a side view of the embodiment of FIG. 5A.

FIG. 8A is a perspective view of the embodiment of FIG. 5A with removable earmuffs added.

FIG. 8B is a side view of the embodiment of FIG. 8A.

Several illustrations and drawings have been presented to better aid in the understanding of the present invention. The scope of the present invention is not limited to what is shown in the figures.

### DETAILED DESCRIPTION OF THE INVENTION

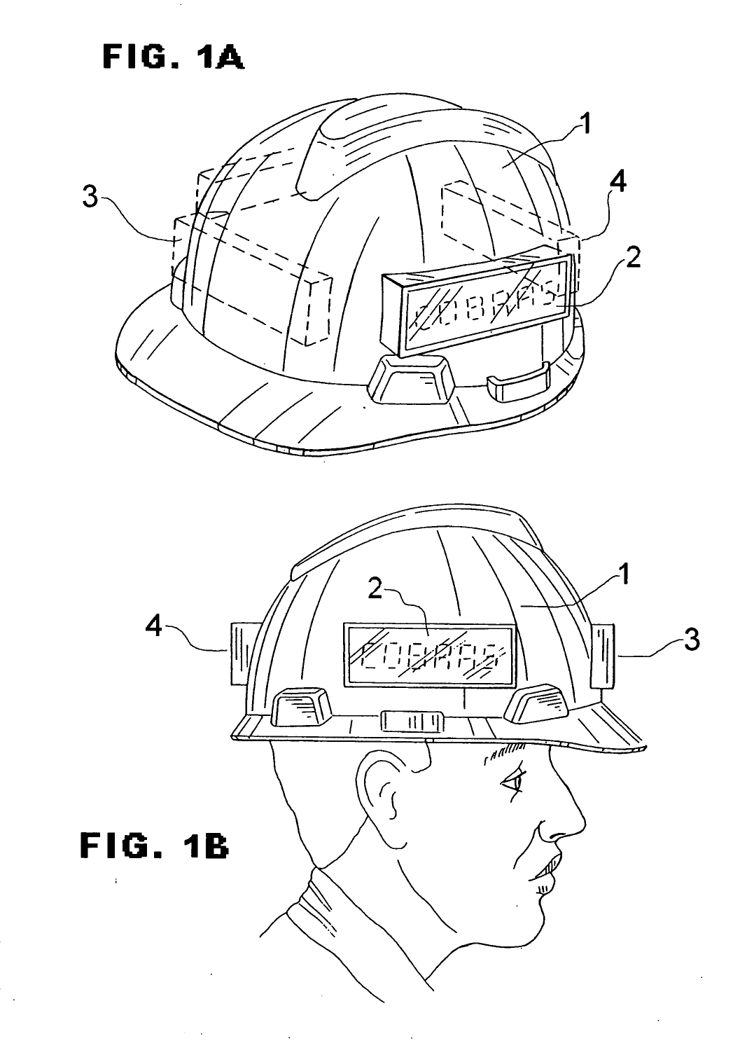

Turning to FIGS. 1A and 1B, a helmet or headgear device 1 can be seen. This can be a helmet or hardhat similar to those used on construction sites, or it can be any other type of headgear or head mounted device. The helmet or headgear 1 can be equipped with a fixed or removable active or passive display or signboard 2 that can be side mounted 2, front mounted 3 or rear mounted 4. The display 2 can be an electronic LED or other electronic device and can be programmable by the wearer to display any message desired. Typical messages include a team name or slogan (such as GO COBRAS) for a sporting event, a title (like INSPECTOR or LINE FORMAN) for a construction site or advertising (like DRINK T-BEER). The display can optionally scroll sideways or from top to bottom. The display can contain batteries or optionally be solar powered (or both). Numerous active and passive displays are known in the art. The preferred type is an LED display. Any type or shape of display is within the scope of the present invention. The preferred display is a rectangular electronic LED display that is bright enough to be seen in the sun and can be programmed to display any banner or message the user desires. The display can generally be used to communicate visually with other people in the vicinity of the wearer (such as other even-attendees). An embodiment of the display can scroll though a longer message like a stock ticker. As stated, the optional scrolling can be horizontal or vertical.

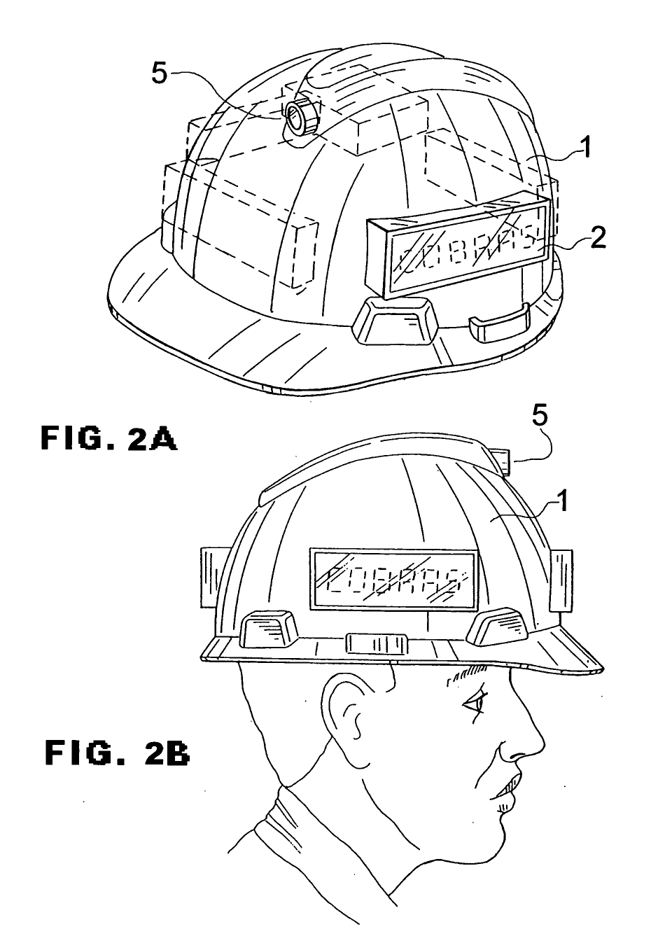

FIGS. 2A and 2B show an embodiment similar to that of FIG. 1A with a fixed or removable camera 5. The camera 5 shown in FIGS. 2A-2B is shown mounted in the center of the helmet or headgear 1; however, it is within the scope of the present invention to mount the camera 5 anywhere. The preferred camera is one with an infinite depth of field so that no focus adjustment is necessary; however any type of camera with any type of lens or iris system can be used. The camera 5 can also be a video camera or camcorder. The camera 5 can be controlled with buttons on the camera or headgear or remotely.

The camera 5 can be mechanical, electronic, or digital. A button can be placed anywhere on the apparatus, or remotely, to activate the camera and take a photo. It is within the scope of the invention to use an electronic camera that can capture a series of images in succession, using a method generally known as progressive shutter capture. The electronic images can be stored in an electronic memory contained in the apparatus, or in a removable memory such as removable memory cards, or by any other storage means. The camera can be self-adjusting or manually adjusted. It is advantageous for the camera to optionally be equipped with automatic film winding or advance if film is used (of course the camera can be totally digital with no film). Any type of lens system is within the scope of the present invention including wide-angle, close-up, telephoto and in a preferred mode zoom.

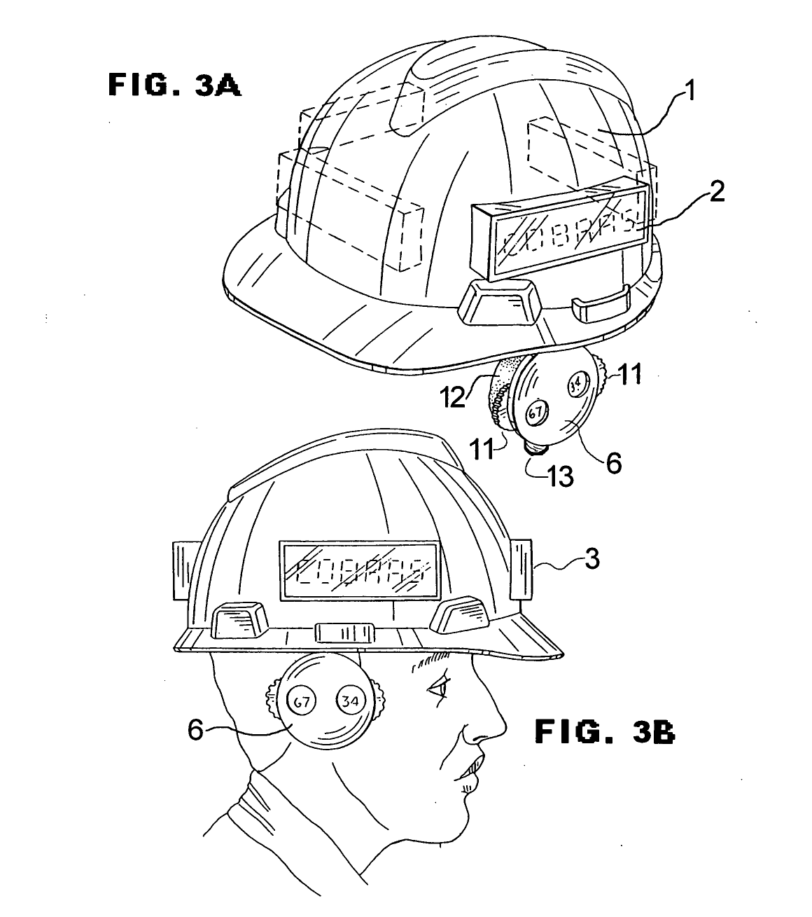

FIGS. 3A and 3B show views of an embodiment of the present invention containing a helmet or other piece of headgear 1 along with fixed or removable earphones 12 that are connected to a fixed or removable radio and/or a digital music device 6. The music device or radio 6 can contain user operated controls 11 and earphones 12 and an optional microphone 13. The radio 6 can be FM, AM, sports channel, TV sound channel, weather channel, scanner or any other type of radio device. It can also contain an optional microphone and/or cellular telephone. The earphone(s) 12 can optionally be noise-canceling and can be used with or without the radio 6. In one embodiment of the invention, the earphone 12 can be used with an optional music device such as a MP3 player. The radio 6 can optionally contain a transmitter that transmit voice or other sound from the microphone 13. The microphone can be any type of microphone such as a button or boom microphone and can be mounted on the headgear, the earphone or anywhere on the device. The audio or music device (or radio) could be located on the user's body away from the headgear and can resemble small popular digital music devices known in the art. In this case, the device could be wired to the earphone on the headgear, or it could communicate wirelessly with the earphone or microphone using a short-range wireless technique such as Bluetooth or any other wireless technique.

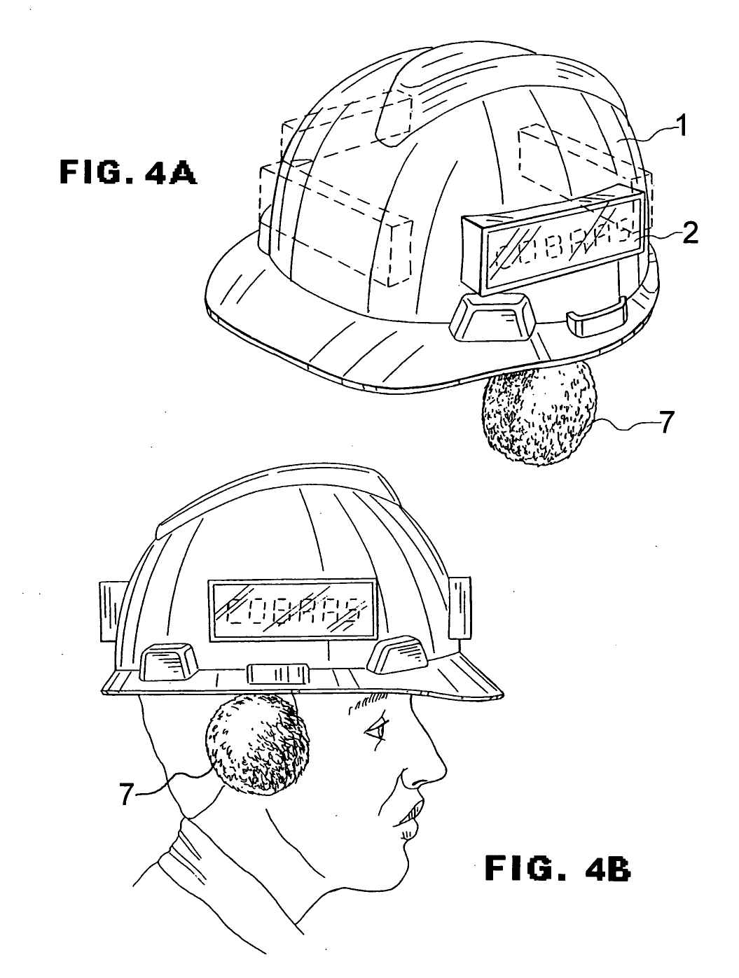

FIGS. 4A-4B show the embodiment of FIGS. 1A-1B with a fixed or removable earmuff 7. The earmuffs 7 shown in FIG. 4A can be attached like the radio or earphone 6 in FIG. 3A or it can use a different attachment method. A slip-out clip or device is the preferred method of mounting the earmuffs 7 or radio/earphone 6. It should be noted that the earmuff 7 can be part of the radio 6 or earphone 12, or it can be totally separate. Because a user will not need earmuffs in the summer or on any warm day, the earmuffs, as all of the equipment on the device, can optionally be removable. Two different types earmuffs can be used with the present invention: those that are simply earmuffs and those that are earmuffs that also combine and earphone. Of course, the present invention also can include a removable earphone that has no earmuff.

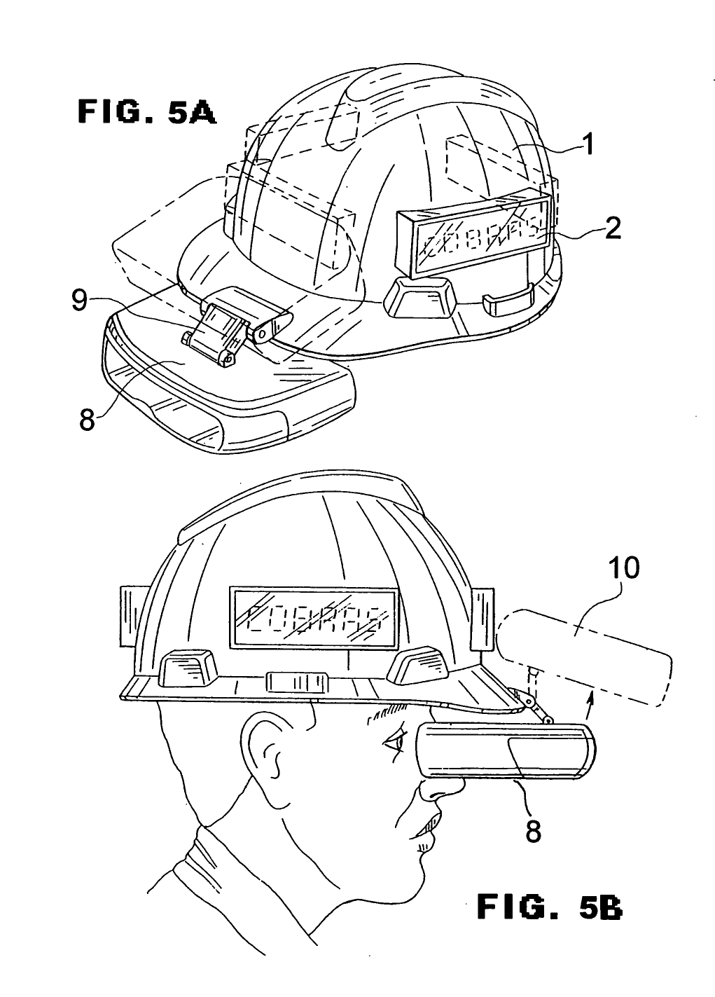

FIGS. 5A and 5B show the helmet or headgear 1 of FIG. 1A with a fixed or removable binocular or other optical element 8. The optical element 8 can be used for sports viewing or for any type of distance viewing. The binocular elements can be optionally adjusted for each user's different eye width specifications. The binocular or optical element 8 can be attached to the helmet or headgear 1 with a swivel 9 that allows the optical element 8 to be moved upward 10 out of the way when not being used. It is within the scope of the present invention to provide an optional lens cover for the optical element 8. This lens cover can be fixed or removable and attached to the lens assembly or could mount on a hinge where it could be swung out of the binocular lens field when not in use. This lens cover can be optionally tinted for glare protection. The lens cover can optionally encompass the entire optical assembly. An optional binocular focusing knob (not shown) can be mounted anywhere on the binocular assembly. It is also within the scope of the present invention to use a fixed binocular focusing mechanism without focus knob or mechanism or automatic focusing. While the optical element of FIGS. 5A-5B is shown as binocular, any type of optical element is within the scope of the present invention including a single lens or two lenses can be used separately from a binocular arrangement.

Optionally a digital camcorder can be coupled to the optical parts of the system. In particular, an active recorder with a display that the user can see (such as an LCD display) could record video or a series of still shots (such as progressive shutter mode). This would allow a user to review a previous or last play of the game. This, or any type of optics used with the invention, can be equipped with a zoom type of lens.

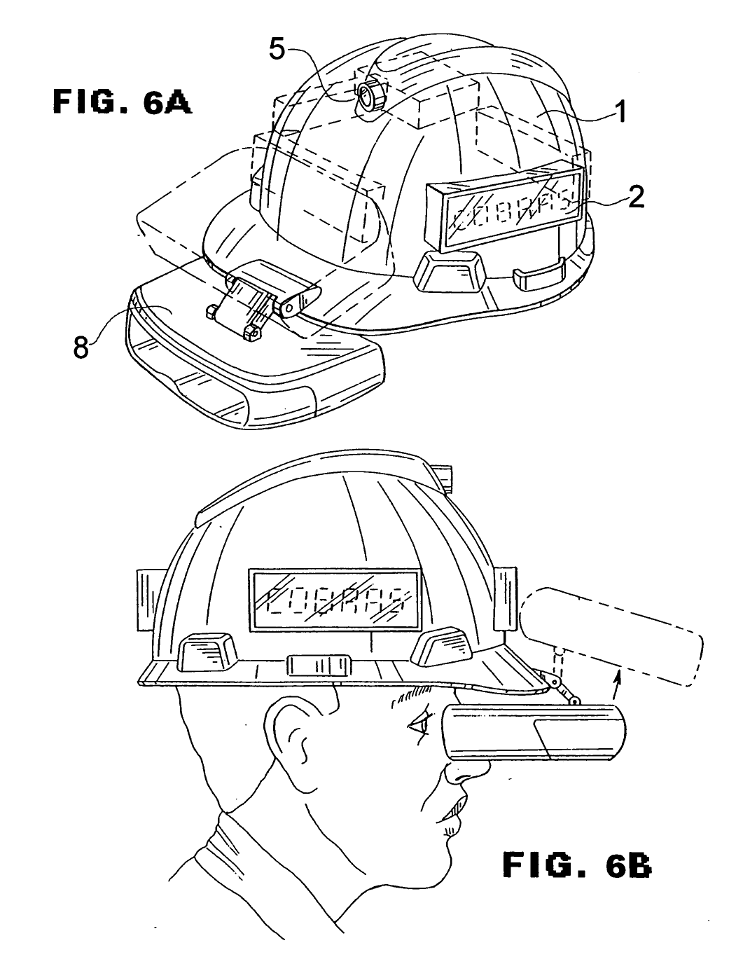

FIGS. 6A-6B show an embodiment of the invention with both a fixed or removable camera 5 and an optical element 8 as well as a display 2.

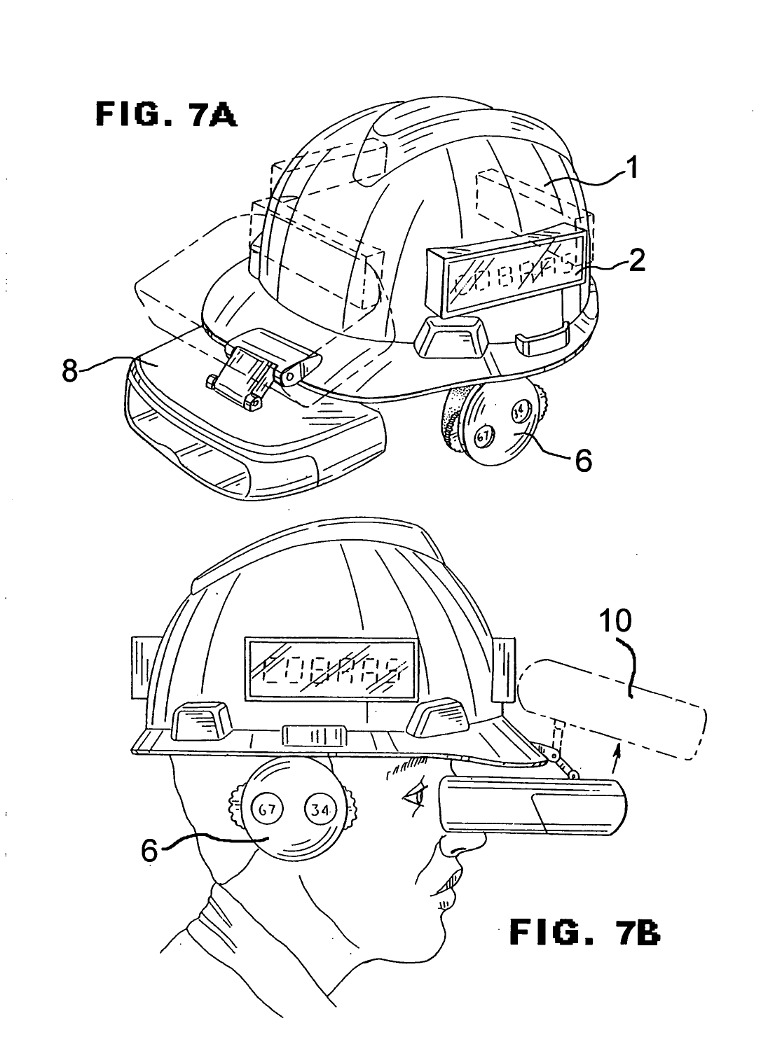

FIGS. 7A-7B show an embodiment of the invention with an optical element 8 and radio 6 as well as display 2.

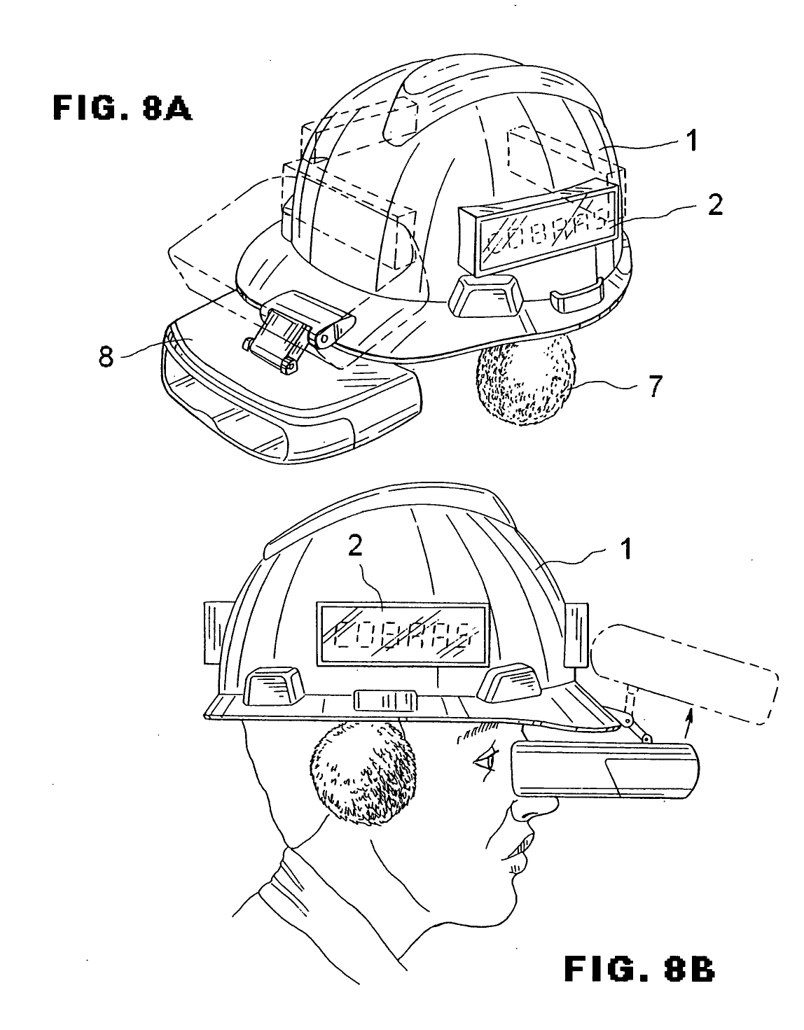

FIGS. 8A-8B show an embodiment of the invention with an optical element 8 and earmuffs 7 as well as display 2. It should be noted that the present invention allows any combination of removable elements to be added or subtracted.

A major feature of the present invention is the user's ability to decide which parts or accessories to use with the headgear. All of the various parts of the present invention including the display, camera, radio and optical system are generally removable (however, any of the parts can be fixed). In this manner, the user can pick and choose which parts he or she will use for that particular day or for a particular event. The choice can be based on the weather, the type of even or on the user's particular preferences.

The embodiments of the invention described here is of course subject to many different variations in structure, design, application and methodology. Because many varying and different embodiments may be made within the scope of the inventive concepts taught, and because many modifications may be made in the embodiments described, these variations and different embodiments are within the scope of the present invention.

I claim:

1. A work or sports accessory comprising:
a headgear unit worn on a user's head;
a display attached to an outside surface of said headgear unit, said display displaying an image, wherein said image is visible to another;
a hands-free optical system attached to said headgear unit wherein said user can view distant objects through said optical system.

2. The accessory of claim 1 wherein said display is removable.

3. The accessory of claim 1 wherein said optical system is removable.

4. The accessory of claim 1 further comprising a fixed or removable radio attached to said headgear unit.

5. The accessory of claim 1 further comprising fixed or removable earmuffs attached to said headgear unit.

6. The accessory of claim 1 further comprising a fixed or removable camera attached to said headgear unit.

7. The accessory of claim 1 wherein said display displays alphanumeric or numeric images.

8. The accessory of claim 1 wherein said display displays advertising.

9. The accessory of claim 1 wherein said display is user programmable.

10. A work or sports accessory comprising:
a headgear unit worn on a user's head;
a fixed or removable display attached to an outside surface of said headgear unit, said display displaying an image, wherein said image is visible to another;
a fixed or removable hands-free optical system attached to said headgear unit wherein said user can view distant objects through said optical system;
an fixed or removable earphone attached to said headgear unit wherein said user can listen to audio through said earphone;
a fixed or removable camera attached to said headgear unit.

11. The sports utility system of claim 10 further comprising a fixed or removable microphone attached to the headgear unit.

12. The sports utility system of claim 10 further comprising fixed or removable earmuffs attached to the headgear unit.

13. A method of configuring a sports viewing system of the type with a head support and an attached optical viewing system comprising the steps of:
making a decision whether or not to attach a removable display signboard to said head support;
attending an event using said sports viewing system to view said event.

14. The method of claim 13 further comprising making a decision whether or not to attach a removable earphone to said head support.

15. The method of claim 13 further comprising making a decision whether or not to attach a removable camera to said head support.

16. The method of claim 13 further comprising making a decision whether or not to attach earmuffs to said head support.

17. The method of claim 13 further comprising making a decision whether or not to attach a radio to said head support.

18. The method of claim 14 wherein said earphone also includes a radio.

19. The method of claim 16 wherein said earmuffs also contain earphones.

20. The method of claim 14 wherein said earphone also contains a microphone.
